(19) United States
(12) Patent Application Publication
(10) Pub. No.: US 2014/0211970 A1
(43) Pub. Date: Jul. 31, 2014

(54) EARPHONE ARRANGEMENTS

(71) Applicant: Incus Laboratories Limited, Stokenchurch (GB)

(72) Inventors: Alastair SIBBALD, Cookham Dean (GB); Robert ALCOCK, Thame (GB); Martin HOWLE, Kenilworth (GB); David Monteith, Worminghall (GB)

(73) Assignee: Incus Laboratories Limited, Stokenchurch (GB)

(21) Appl. No.: 14/167,046

(22) Filed: Jan. 29, 2014

(30) Foreign Application Priority Data
Jan. 31, 2013 (GB) 1301691.0

(51) Int. Cl. H04R 3/00

(52) U.S. Cl. CPC H04R 3/002
USPC 381/309; 381/71.6

(57) ABSTRACT

The invention provides earphone arrangements for use with electronic host devices, such as cellular telephone handsets and music storage and reproduction devices, and it provides in particular earphone arrangements with ambient noise cancellation (“ANC”). Typically, in prior arrangements, the complex signal processing required for ANC is carried out in the earphones themselves and/or in a pod connected between the earphones and the host device. The invention configures the processing elements such that the ANC signal-processing function is transferred to an ANC processor incorporated into the host device. A non-volatile electronic data storage device, such as an EPROM, provided in the connection path between the earphones and the host device is configured to store calibratory information, indicative of performance criteria of specific microspeaker and microphone components incorporated into the earphones, required to condition the operation of the ANC processor to compensate for departures from predetermined standards of the performance criteria of either or both components. The earphone arrangement is thus simplified and reduced in cost, and moreover can be manufactured, calibrated and supplied independently of any host device.

The present invention relates to earphone arrangements for use with electronic host devices, such as cellular telephone handsets and/or music storage and reproduction devices. The term “earphone” is intended herein to have special reference to in-ear listening devices, including so-called ear-buds, but is intended also to embrace larger earphones and headphones.

It is well known to be advantageous to provide such earphone arrangements with ambient noise cancellation (“ANC”), whereby background noise can be suppressed, enabling the listener to better hear audio signals provided from the host device, especially in noisy environments. It will be appreciated, in this context, that ANC is a term of art, and its use herein is not intended to imply that perfect or total cancellation of ambient noise is achieved; merely that ambient noise as perceived by a listener can be significantly reduced.

Typical host devices, as indicated above, comprise music storage devices, such as MP3 players and the like, and cellular telephone handsets, which usually also have the capacity to store and replay music.

Usually, earphones are sold as pairs, connectable to the host device by a common connector cable containing multiple connection cores, thus allowing for stereophonic listening. Typically also, the cable supports and connects with a so-called pod, which is located between the earphones and the host device; the pod housing electrical and/or electronic components provided, for example, to allow the listener to adjust one or more of the characteristics of sound signals output from the host device to his or her liking. The free end of the cable is fitted with a connector that is insertable into and removable from a corresponding socket on the host device to make and break the connection with the earphones at the user's discretion.

Where the host device is a cellular telephone handset, a single earphone alone might be used, in conjunction with a microphone located on the earphone cable so that it can be disposed near the mouth of the user so as to pick up the user's speech and relay it into the host device via the multi-cored cable. However, it is more common to use a pair of earphones (with the same single-microphone arrangement for user's voice pick-up), because this allows the user to listen to stereophonic music and/or other audio material that may be stored in a music player application on the cellular phone handset. Earphone arrangements which include a mouth-proximal voice pick-up microphone for cellular communications in this manner are commonly termed “headsets”; the voice pick-up microphone being commonly termed simply “voice microphone”.

In any event, the technical requirements that need to be met in order to provide a useful degree of ANC in these circumstances are extremely exacting and, although the thin rubber ear-contacting flanges (known as “ear-buds”) employed by “in-ear” earphones might appear to effectively seal the earphone assembly into the listener's ear-canal, an earphone thus positioned and located does not provide an effective acoustic seal between the listener's ear canal and the ambient environment, because low-frequency sound vibrations can still pass through the rubber flanges themselves.

There are two alternative technologies that can be utilised for ambient noise-cancellation, known respectively as the “feedforward” method, and the “feedback” method. An ANC system based on the feedback method is disclosed in U.S. Pat. No. 4,985,925 whereas an ANC system based on the feedforward method is disclosed in U.S. Pat. No. 5,138,664. The present invention is applicable to ANC systems based on either method, but the feedforward method is preferred, and thus systems based on that technology will be described hereinafter.

In the feedforward method, incoming ambient-noise signals are detected by means of a small microphone in the earphone, and used to create phase-inverted noise signals which are played through a microspeaker, also located in the earphone, into an ear of the listener. The timing is organised such that such that the noise signal and its phase-inverted counterpart arrive together at the listener's tympanic membrane, at which point destructive cancellation occurs between the two signals provided that the phase-inverted (cancellation) signal is of equal magnitude and opposite polarity to the ambient noise signal, in which ideal case, the resultant, summed signal is zero.

In order to achieve a useful degree of noise-cancellation, however, it is important for the noise-cancellation signal to closely match the actual noise signal in terms of both amplitude and phase. In order to achieve a reasonably good degree of cancellation, say 20 dB (90%) reduction in the ambient noise perceived by a listener, it is necessary for the amplitude of the cancellation signal to match the amplitude of the noise signal to within 0.9 dB. Moreover, the relative phase of the signals must simultaneously match to within ±5°, and this requirement for amplitude and phase matching must be maintained throughout the range of frequencies.

The phase-matching criterion creates a problem for the signal-processing requirements of ambient noise cancelling ear-phones in that the cancellation signal and the noise signal must be time-aligned, as described in detail in GB-B-2,434,708. For example, at a frequency of 1 kHz, the 5° phase-matching requirement (to achieve 20 dB cancellation) corresponds to a time period of only 13.8 μs which, in turn, corresponds to an acoustic path distance of 4.8 mm However, although analogue signal-processing filters and amplifiers are effectively “instantaneous” in operation, there are inherent time-delays in all conventional digital signal-processing schemes, incurred largely during the analogue-to-digital (A-to-D) and digital-to-analogue (D-to-A) conversion stages, which contribute to a signal throughput “latency”, which is typically tens of microseconds in duration. Accordingly, because of the low-latency requirement for ANC processing, conventional DSPs and digital signal-processing means are unsuitable for ANC applications.

The amplitude-matching criterion presents particular difficulty for the manufacture of ear-phone arrangements with ANC, because the microspeakers and microphones used in their construction cannot be consistently manufactured with adequate precision in terms of their electroacoustic and acoustoelectric sensitivities. In practice, suitable microspeakers in the diameter range 9 mm to 13 mm are supplied with a typical sensitivity tolerance range of ±3 dB, and suitable 4 mm and 6 mm electret microphones are usually supplied with tolerances of ±3 dB or ±4 dB. Consequently, in the extreme, there is the possibility that any single random microphone-microspeaker combination used together in an earphone arrangement with ANC might have a combined sensitivity factor that could differ by as much as 6 dB from the average, and expected, value. Accordingly, it is not possible to manufacture ANC earphones without taking these sensitivity variations into account, and then compensating for them by adjusting the amplitude (“level”) of the ANC signal to compensate for any variations from the required value; i.e. each component pairing used must be calibrated against a standard performance criterion.

Ways of achieving such calibration by measuring the performance of component pairings and storing an appropriate calibration factor for interrogation in an electronic storage medium such as an EPROM located in the earphone housing, are described and claimed in GB-A-2475526, which is commonly owned and hereby incorporated by reference, and which also sets out in detail the specific phase and amplitude matching requirements themselves, but implementing such calibration with a dedicated ANC processor imposes practical difficulties including the need to provide battery power for the circuitry and additional electrical connections.

Moreover, digital microphones are now replacing analogue microphones in cellular phone handset designs and thus the internal circuitry of the handsets is conditioned to receive microphone output data in the form of a digital bitstream, synchronized to a clock signal (typically 3 MHz). Typically, the outputs are connected directly together and used as “left-right” pairs using a “left/right select” control pin that is present on each microphone. A typical digital microphone of this type, such as the Hosiden KUS5147, requires 4 electrical connections (power, data, clock and ground).

It is not possible, however, to incorporate such microphones into an EPROM-based calibration system of the kind described earlier, because of the large number of electrical connections—eight in all—needed to each of the earphones, namely:
common ground (x1)
analogue speaker drive (x1)
EPROM (x3: clock; data; power)
Digital Microphone (x3: power, data, clock)

Also, there is insufficient space in the earphone housing structure to accommodate the digital microphone, the eight-conductor wiring, the EPROM and the various associated passive components.

In terms of the conventional, pod-based, battery-powered self-contained ANC earphone arrangements known to date, the use of digital microphones would not be considered because any suitable digital-processing would consume a relatively large current, limiting the battery life, which is a critical design factor. Moreover, such a system would be expensive and there would still be some significant latency present.

The phase matching requirements for ANC are of course related to the precise timing with which the directly heard ambient noise and the phase inverted noise cancellation signal are received at the user's eardrum. This presents considerable practical difficulties, and tends to militate against the use of digital processing, where latency involved (particularly in analogue-to-digital and digital-to-analogue conversions) introduces delays into the noise cancellation signal path. These difficulties can be mitigated to an extent, as described and claimed in GB-A-2,493,206, by the use of earphones that are constructed so as to insert a well-defined delay into the path followed to the eardrum by the directly-received ambient noise, thereby rendering the earphones to some degree latency tolerant.

In any event, because of the considerable demands made by ANC on the matching of amplitude and phase with precise timing, it has been the practise to utilise lumped systems in which all components, including the ANC processor, are closely bundled into the earphone housing itself and the associated pod structure. This, however, leads typically to the use of systems in which earphones and the pods contain significant electronic components, which is costly and requires significant operating power that needs to be supplied either by replaceable batteries, such as AAA cells, or by rechargeable cells. In either event, this represents an inconvenient and expensive solution.

It is an object of this invention to address the foregoing difficulties and, in accordance with the invention there is provided an earphone arrangement for communication with an electronic host device, said host device being capable of providing and receiving audio signals and being also equipped with an ambient noise cancelling (ANC) processor; the earphone arrangement comprising:
an earphone supporting a digital microphone mounted to receive ambient noise and a microspeaker mounted to project audio signals, provided by the host device, into the ear of a user of the arrangement;
a communication path connecting the earphone over multiple electrical connections to the host device by way of a connector forming part of said path;

the connector being connectable to and removable from the host device to make and break said path, whereby ambient noise signals from said digital microphone conveyed along said communication path from the earphone to the host device are provided to said ANC processor within the host device for use therein to reduce the effect of said ambient noise on audio signals provided to the earphone by the processor; and
an electronic data storage device located in said communication path and configured to contain digital information indicative of performance criteria of said microspeaker and said digital microphone thereby to condition the operation of said ANC processor to compensate for departures of said criteria from predetermined standards.

By this means, the ANC signal-processing function is transferred from the headset pod into the host device, where its additional cost and power requirements are of limited concern. This reduces significantly the cost, weight and size of the headset arrangement (earphone(s), voice microphone and cord), which can be connected to the handset either by a standard 3.5 mm TRRS connector, or by a multi-way connector, for example as described in GB-B-2,449,083. Furthermore, because the calibration data is stored in the electronic storage device, the invention enables the earphone arrangement to be manufactured, calibrated and supplied independently of any host device; the earphone arrangement providing the host device and its on-board ANC processor with the ambient sound signals and the calibratory information that is required.

The invention is thus based on a carefully distributed combination of components the selection and configuration of some at least of which are counter-intuitive to those skilled in the art.

In some preferred embodiments of the invention, said communication path comprises a multi-cored electrical cable.

It is further preferred for the arrangement to include a pair of earphones to permit stereophonic listening

Some preferred embodiments of the invention, particularly suited to use with a cellular telephone handset as the host device, further comprise a voice pick-up microphone, connected into said communication path; thereby allowing the user to speak and engage in telephonic communication via the host device.

Some alternative preferred embodiments of the invention for use with a cellular telephone handset as the host device, are configured to utilise at least one said digital microphone, used within the earphone arrangement to receive ambient noise, to pick up a user's voice and convey voice signals into the host device.

Some preferred embodiments of the invention comprise a pod connected into said communication path and housing said electronic storage device.

It is further preferred that said electronic storage device is configured to contain further data pertaining to the operation of said ANC processor in addition to said electrical signals indicative of performance criteria of said microspeaker and said digital microphone.

It is preferred that said electronic storage device is a non-volatile memory element, such as an EPROM or non-volatile RAM or the like, and further preferences are for said electronic storage device to be housed either within said pod or within said connector.

Where a non-volatile memory element is employed, it is preferred in some circumstances to provide a microprocessor or microcontroller in communication with said memory element, and further that said memory element comprises part of said microprocessor or microcontroller.

In some preferred embodiments of the invention, said earphone incorporates an acoustic delay path for directly received ambient sounds to provide additional time for ANC processing to occur and thereby assist in matching the phase of noise cancelling signals to that of said directly received sounds.

Preferably, an arrangement in accordance with the invention as recited herein is incorporated into a system further comprising a host device for selective interconnection with said arrangement by way of said connector, wherein the host device incorporates an ANC processor conditioned to co-operate with said earphone arrangement.

It is further preferred for the said host device to support a software application configured to control and/or adjust at least one operating function of said ANC processor.

In some systems of the kind referred to in the two immediately preceding paragraphs, it is preferred that said ANC processor is conditioned to perform feedforward ANC processing. In other such systems, it is preferred that said ANC processor is conditioned to perform feedback ANC processing.

Some significant benefits of the invention are as follows:
1. The earphone arrangement, having no signal-processing electronics, has a particularly low manufacturing cost.
2. No batteries are required, further reducing manufacturing and operating costs, and also size and weight.
3. The earphone arrangement is small and lightweight.
4. The active earphone components (microspeaker and digital microphone) are calibrated independently of any host device, so that the earphone arrangements and hosts can each be manufactured and supplied by a range of different manufacturers and routes.
5. Every earphone arrangement contains its own calibration data, and so each one can be used with different host devices (such as a cellular phone handset, a radio, a music player and so on), several of which may be owned by a user.
6. A damaged earphone arrangement can simply be replaced by another one, because each bears its own calibration data, unlike existing ANC music-players, which are calibrated only for their own, supplied (“bundled”) earphones).
7. The ANC signal-processing takes place on a host device which is typically provided with a graphics screen, enabling a variety of ANC software applications to interact with the earphone arrangement, providing facilities such as noise-level monitoring, automatic switch-off and switch-on, selection of user-preferences and so on.

It will be appreciated that the invention applies to all ANC earphone arrangements which can be used as an accessory in conjunction with mobile electronic host devices, both monophonic and stereophonic. However, for clarity of explanation, the following description will be restricted to a stereophonic headset as the example ANC accessory.

Thus, in a preferred embodiment of the invention, the arrangement takes the form of a stereophonic headset including a pair of earphones containing respective digital microphones configured as left-channel and right-channel, respectively, thus enabling their outputs to be combined to form a single, composite bit-stream and reducing the number of connecting wires to the host device.

In this embodiment, the cable from each earphone is joined into a small pod, in a conventional manner, with the pod bearing several switches for user selection of telephony and music playback functions. The pod is connected to the mobile device either through a multi-way connector, or via a standard 3.5 mm TRRS socket.

The microphone/microspeaker pairs in each earphone are calibrated as described below, and the calibration data recorded in an EPROM as before. For ease of manufacture, the EPROM can be situated either inside the pod, or within the plug connecting to the host device, although it can be located anywhere within the headset as a whole. In addition to the calibration data, the EPROM may be conditioned to record additional data, such as the ANC processing filter parameters and coefficients, and the specific ANC level settings.

Preferably there is included a low-cost microcontroller device, and associated components, to make interaction between the headset components (EPROM, digital microphones and micro-speakers) and the mobile device more efficient and reliable. In this case, the EPROM can be one which is available as an integral element within the microcontroller itself, thus saving cost and complexity. The microcontroller is arranged to participate in an initialisation “handshake” with the host device when it is plugged in to it, transferring relevant data from the EPROM, and then transmitting the digital microphone data into the host device.

Calibration of the earphones is typically carried out by mounting the earphones (coupled to appropriate ANC-processing having an adjustable ANC signal level) on to a pair of artificial-ear couplers (such as a Bruel & Kjaer Type 4157 Ear Simulator for use with insert earphones), exposing them to suitable external acoustic signals (such as tones), and then adjusting the respective ANC signal levels to achieve minimum residual noise as detected by each artificial-ear coupler. At this stage, the ANC signal level data, together with any other required data, is transmitted into the EPROM in the headset assembly where it is stored for future interrogation.

The invention overcomes limitations of the prior-art ANC module system in that the use of digital microphones generates signals that are compatible with the processors recently introduced into cellular phones and music players, with consequent signal-latency benefits, and the transfer of ANC calibration data from the earphone arrangement to the host device enables ANC processing to be carried out by host devices which are manufactured and supplied independently and separately from the earphone arrangement which is connectable to and removable from it. The earphone arrangement of the present invention permits the incorporation of a digital microphone, which, as described earlier, has hitherto been contra-indicated for ANC because of its unsuitable latency properties.

In order that the invention may be clearly understood and readily carried into effect, one embodiment thereof will now be described, by way of example only, with reference to the accompanying drawings, of which:

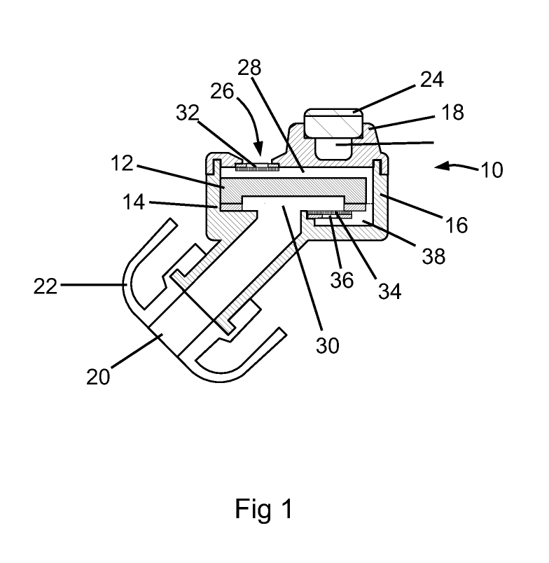

FIG. 1 shows, in a front elevation, sectional view, an earphone arrangement according to one embodiment of the invention;

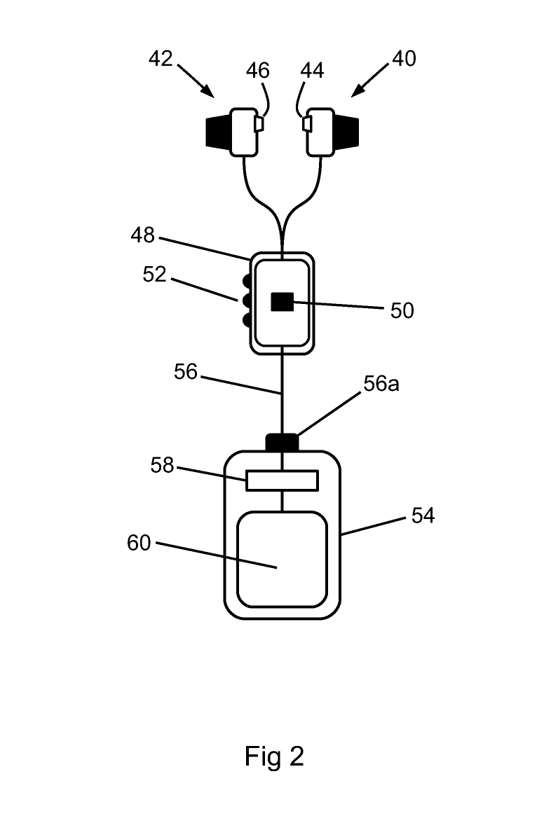

FIGS. 2 through 4 show in simplified block diagrammatic form, systems including earphone arrangements in accordance with further embodiments of the invention and host devices selectively connectable therewith; and

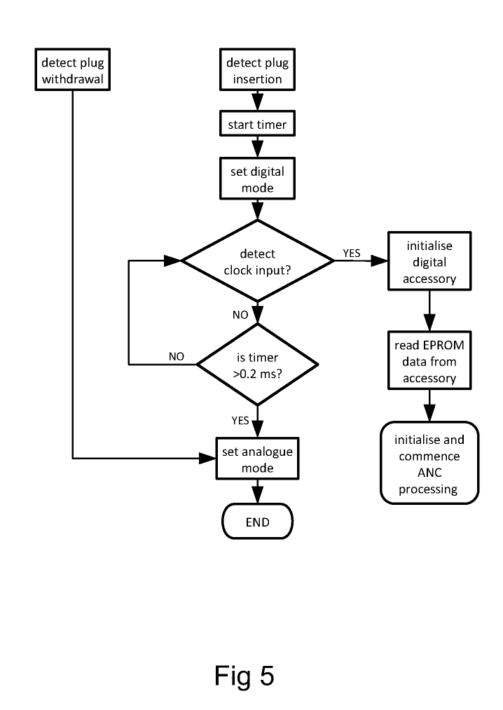

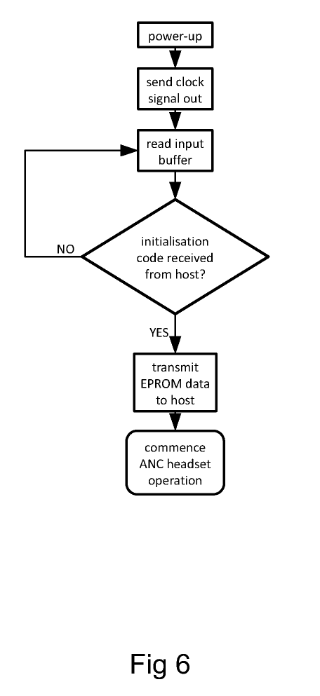

FIGS. 5 and 6 show example flow diagrams relating respectively to operations of a host device and an earphone arrangement according to an example of the invention.

Referring now to FIG. 1, there is shown an ear-bud type earphone 10 of the same general kind as that disclosed in the aforementioned UK patent application No. GB-A-2,493,206. The earphone 10 contains a microspeaker 12 which is sealed, using an adhesive ring 14, onto a front housing 16. The front housing 16 is, in turn, sealed to a rear housing 18, and the front housing 16 includes an outlet port 20 on to which the rubber ear-bud flanges 22 are affixed.

The rear housing 18 supports a digital microphone 24, and is formed with a rear vent 26 linking the volume 28 of enclosed air (the “rear volume”) lying in the rear housing 18 behind the microspeaker 12 to the external ambient. The volume 30 of air in the front housing 16 that lies between the front of the microspeaker 12 and the inner extent of the outlet port 20, is termed the “front volume”.

The rear housing 18 is also used to carry and locate the electrical flex connections (not shown in FIG. 1, for clarity) to the microspeaker 12 and from the digital microphone 24. The earphone 10 also incorporates two acoustic resistors 32 and 34 (typically nylon mesh discs), sealed respectively over the rear vent 26 and over an acoustic coupling vent 36 which opens into a connecting air channel 38 acoustically linking the front and rear volumes 30 and 28. These are present to tune and optimise the frequency response for efficient ANC performance. The rubber flange “ear-buds” 22, when inserted into the ear canal entrance of a user, form a seal and couple acoustically the front volume 30 of the earphone 10 to the ear canal of the user.

The invention is not restricted to ear-bud type earphones, featuring rubber flange ear-buds, but is also applicable to all in-ear earphones which are located in the concha cavity of the ear, including various loose-fitting designs, as well as to pad-on-ear and circumaural ANC headphones.

Referring now to FIG. 2, a pair of ANC earphones 40 and 42, each bearing a digital microphone, 44 and 46 respectively, is wired into a small, in-line pod unit 48. The pod unit 48 contains an electronic memory means 50, referred to hereinafter as an EPROM, but which could alternatively be a non-volatile RAM, or a one-time-programmable EPROM (OTP-EPROM), or any other non-volatile memory device suitable for storing small amounts of digital data for subsequent retrieval when required. In headset format (as opposed to stereophonic earphone arrangement format), the pod is also provided with several user-switches 52 for controlling telephony and music playback functions. The earphones 40, 42, EPROM 50 and switches 52 (if present) and the pod 48 are connected to a mobile electronic “host” device 54, such as a cellular phone handset, over a communication path consisting of a cable 56 containing multiple electrical connections, via an electrical connector 56a. Signals from the digital microphones 44 and 46, representing the external ambient noise, are fed to an ANC processing unit 58 on the host device 54. The processing unit 58 may either be comprised within the main CPU of the device, or in a digital signal processor separate from the main CPU, or in an “audio-hub” processor or the like. Optionally, the ANC processing can be controlled and adjusted by a software application 60 on the host device, featuring a graphical-user-interface, to set, for example, user preferences for optimal ANC level, automatic activation, and so on.

In headset format, for use with cellular phones, a (user's) voice signal is required, and this is usually provided by a small voice pick-up microphone (not shown) situated in the pod 48. However, in arrangements according to some embodiments of the invention, the need for such an additional voice microphone is obviated by detecting the user's voice by means of one or both of the ANC microphones 44 and/or 46, since these are situated quite close to the user's mouth.

Alternatively, if a noise-cancelling type of microphone system is preferred for the “voice transmit” function, to reduce ambient noise around the talker being heard by the distant listener, a conventional noise cancelling microphone pair (not shown) can be included in the pod 48. Alternatively, a single uni-directional microphone can be included in the pod 48. Unidirectional microphones are not commonly used at present, but can provide intrinsic ambient noise reduction without the need for the additional electronics that a noise-cancelling voice-microphone pair would require.

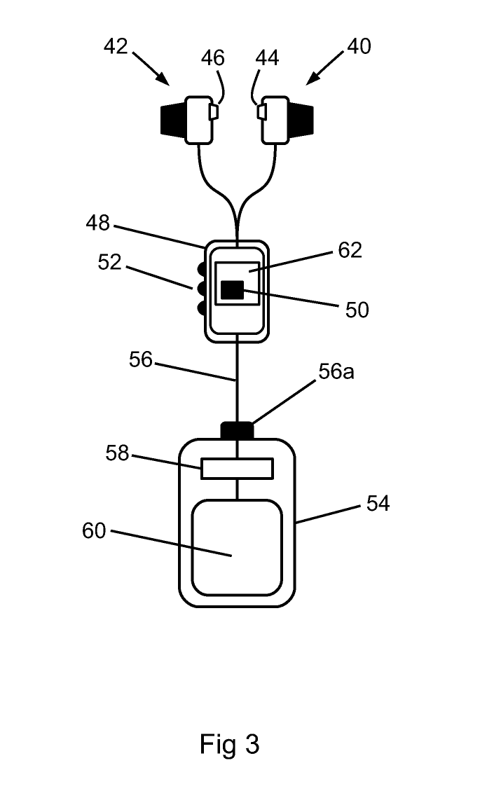

FIG. 3 shows another embodiment of the invention, similar to that of FIG. 2, but which includes a microcontroller 62 in the pod unit 48. The use of a microcontroller such as 62 adds little to the cost, but facilitates the digital interconnections and initialisation between the headset arrangement and the host device 54. Preferably, instead of having both an EPROM and a microcontroller, the latter incorporates an integral EPROM or non-volatile RAM, and this is used as the electronic memory means to store the ANC calibration data. This is also smaller, less costly and simpler.

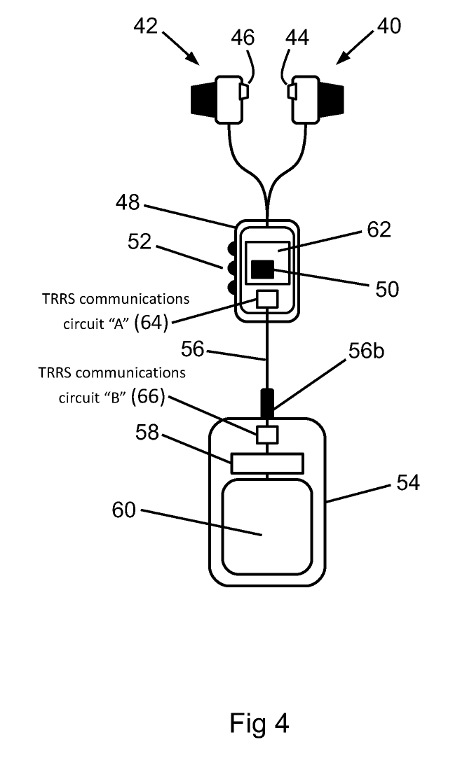

Fire 4 shows another preferred embodiment of the invention, in which the system is adapted to use a four-way, 3.5 mm TRRS connection 56b, rather than a multi-way connector 56a, to the host device 54 because this has become a standard and preferred connection means. The use of only a 4-way connection requires additional electronic circuitry 64 within the pod unit 48 to process the various digital and analogue signals, and a power supply, both into, and out of, of the earphone arrangement, and this is shown in FIG. 4 as TRRS communications circuit “A”. A corresponding complementary circuit 66, TRRS communications circuit “B”, is present within the host device.

When the headset is plugged in to the cellular phone handset (host device 54), its presence is detected and the appropriate electrical and signal connections are established between the earphone arrangement and host. Then, the ANC calibration data (and additional data), in respect of the headset is read by the host device 54, which adjusts its ANC processing 58 accordingly for optimal effect. An example of such an initialisation interaction is shown in the self-explanatory flow-diagrams of FIG. 5 (for the host device), and FIG. 6 (for the earphone arrangement (headset). The initial default setting for the host device 54 is to accept a conventional analogue input, switching to digital mode when the earphone arrangement (headset) is plugged in.

1. An earphone arrangement for communication with an electronic host device, said host device being capable of providing and receiving audio signals and being also equipped with an ambient noise cancelling (ANC) processor; the earphone arrangement comprising:
an earphone supporting a digital microphone mounted to receive ambient noise and a microspeaker mounted to project audio signals, provided by the host device, into the ear of a user of the arrangement;
a communication path connecting the earphone over multiple electrical connections to the host device by way of a connector forming part of said path;
the connector being connectable to and removable from the host device to make and break said path, whereby ambient noise signals from said digital microphone conveyed along said communication path from the earphone to the host device are provided to said ANC processor within the host device for use therein to reduce the effect of said ambient noise on audio signals provided to the earphone by the processor; and
an electronic data storage device located in said communication path and configured to contain digital information indicative of performance criteria of said microspeaker and said digital microphone thereby to condition the operation of said ANC processor to compensate for departures of said criteria from predetermined standards.

2. An earphone arrangement according to claim 1 wherein said communication path comprises a multi-cored electrical cable.

3. An earphone arrangement according to claim 1, further comprising a pair of earphones to permit stereophonic listening.

4. An earphone arrangement according to claim 1, further comprising a voice pick-up microphone, connected into said communication path; thereby allowing the user to speak and engage in telephonic communication via the host device.

5. An earphone arrangement according to claim 1 configured to utilise said digital microphone to pick up a user's voice and convey voice signals into the host device.

6. An earphone arrangement according to claim 1, further comprising a pod connected into said communication path and housing said electronic storage device.

7. An earphone arrangement according to claim 1, wherein said electronic storage device is configured to contain further data pertaining to the operation of said ANC processor in addition to said electrical signals indicative of performance criteria of said microspeaker and said digital microphone.

8. An earphone arrangement according to claim 1, wherein said electronic storage device comprises an EPROM.

9. An earphone arrangement according to claim 8, wherein said EPROM is housed within said pod.

10. An earphone arrangement according to claim 8, wherein said EPROM is housed within said connector.

11. An earphone arrangement according to claim 8, further comprising a microcontroller in communication with said EPROM.

12. An earphone arrangement according to claim 11 wherein said EPROM comprises part of said microcontroller.

13. An earphone arrangement according to claim 1, wherein said connector comprises a 3.5 mm TRRS connector.

14. An earphone arrangement according to claim 1, wherein said earphone incorporates an acoustic delay path for directly received ambient sounds to provide additional time for ANC processing to occur and thereby assist in matching the phase of noise cancelling signals to that of said directly received sounds.

15. A system comprising an earphone arrangement according to claim 1 and a host device for selective interconnection with said arrangement by way of said connector, wherein the host device incorporates an ANC processor conditioned to co-operate with said earphone arrangement.

16. A system according to claim 15, wherein said host device supports a software application configured to control and/or adjust at least one operating function of said ANC processor.

17. A system according to claim 15, wherein said ANC processor is conditioned to perform feedforward ANC processing.

18. A system according to claim 15, wherein said ANC processor is conditioned to perform feedback ANC processing.
